(19) United States
(12) Patent Application Publication
(10) Pub. No.: US 2026/0289793 A1
(43) Pub. Date: Sep. 24, 2026

(54) IMAGE SEGMENTATION AND FEATURE EXTRACTION USING NEURAL NETWORKS AND A SPATIO-TEMPORAL FILTER

(71) Applicant: DOLBY LABORATORIES LICENSING CORPORATION

(72) Inventors: Subhadra Gopalakrishnan, Santa Clara, CA (US); Jaclyn Anne Pytlarz, San Jose, CA (US)

(73) Assignee: DOLBY LABORATORIES LICENSING CORPORATION, (US)

(21) Appl. No.: 19/490,951

(22) PCT Filed: Jun. 4, 2024
(86) PCT No.: PCT/US2024/032388

§ 371 Date: Dec. 8, 2025

Related U.S. Application Data
(60) Provisional application No. 63/507,181, filed on Jun. 9, 2023.

(30) Foreign Application Priority Data
Aug. 2, 2023 (EP) 23189251.4

(51) Int. Cl. G06T 7/174; G06T 3/40

(52) U.S. Cl. CPC G06T 7/174; G06T 3/40; G06T 2207/20084; G06T 2207/20182

(57) ABSTRACT

Methods and systems for image-segmentation aer described. Given an input sequence of video pictures, a feature extraction neural network generates from early layers a preliminary set of feature maps at full resolution. The output of the feature extraction network is down-sampled before being fed to a segmentation neural network which generates a source-segmentation map at a lower resolution. After upsampling the source-segmentation map at the full resolution, given filtering kernels that are based on the preliminary set of feature maps, a spatiotemporal trilateral filter is applied to the upsampled source-segmentation map to generate an output segmentation map.

### CROSS-REFERENCE TO RELATED APPLICATIONS

This application claims the benefit of priority from U.S. Provisional Patent Application No. 63/507,181, filed Jun. 9, 2023, and European Patent Application No. 23189251.4, filed Aug. 2, 2023, each of which is incorporated by reference herein in its entirety.

### TECHNOLOGY

The present invention relates generally to images. More particularly, an embodiment of the present invention relates to techniques for image segmentation and feature extraction using a spatiotemporal filter.

### BACKGROUND

Image segmentation and feature extraction are key image processing operations in a variety of image and video applications, including computer vision, image coding (compression), and display management. Given an input image, such operations will output semantic or geometric information about a scene in the image. Without limitation, the output of such operations may be denoted, interchangeably, as a “feature map” or as a “segmentation map.” Given a feature map or a segmentation map, in some embodiments, one may perform a thresholding operation, thus generating a corresponding binary “feature mask” or “segmentation mask.” In recent years, segmentation techniques based on artificial intelligence and deep learning were also examined.

As used herein, the term “deep learning” refers to neural networks having at least three layers, and preferably more than three layers. In such neural networks, in order to address computational complexity issues, it is common to operate in low-resolution images and up-sample the output; however, classical up-sampling techniques, such as bilinear or bicubic interpolation, might create additional artifacts, such as blurring, thus compromising the quality of the output. To improve existing image segmentation and feature extraction techniques, as appreciated by the inventors here, improved image-segmentation and feature extraction techniques are developed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts a processing pipeline for image segmentation and feature extraction according to an example embodiment of the present invention;

FIG. 2 depicts examples of the Gaussian kernels being used in spatiotemporal filtering according to an example embodiment of the present invention; and

FIG. 3 depicts examples of feature maps for a video frame.

### DESCRIPTION OF EXAMPLE EMBODIMENTS

Methods for image segmentation and feature extraction in video sequences are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

### SUMMARY

Example embodiments described herein relate to methods for image segmentation for video sequences. In an embodiment, a processor receives a sequence of pictures in a video sequence at a high spatial resolution. Then, for a current picture (102) in the sequence of video pictures, the processor:
applies (105) a feature extraction neural network (NN) to the current picture to generate at the high spatial resolution: a first set of one or more feature-maps (107) extracted from early layers of the feature extraction NN, and an output set of one or more feature-maps (109) from the feature extraction NN;
generates (110) in a low spatial resolution a spatially down-sampled version of the output set of feature maps;
applies (115) a segmentation neural network to the down-sampled version of the output set of feature maps to generate a segmentation map (117) at the low spatial resolution;
generates (120) a source segmentation map (122) at the high spatial resolution by applying a spatial up-sampling to the segmentation map;
generates filter-parameters for a spatiotemporal filter based on the first set of feature-maps (107); and
applies the spatiotemporal filter to the source segmentation map to generate an output segmentation map (127).

### Image Segmentation and Feature Extraction Pipeline

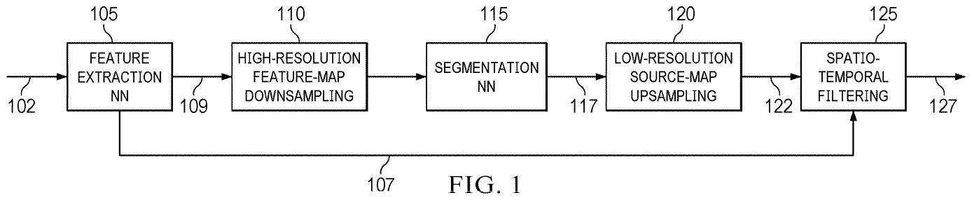

FIG. 1 depicts an example processing pipeline for image segmentation and feature extraction according to an embodiment. As depicted in FIG. 1, input to the process is a sequence of video images (102) in high resolution. In an embodiment, segmentation and feature extraction for a frame at time t (e.g., Fₜ) are performed based on a temporal window of 2T+1 consecutive frames, e.g., T=1 or T=3, which includes the Fₜ frame (the frame to be processed), T prior frames, and T subsequent frames. In an embodiment, each frame is processed by a feature-extraction neural network (105), followed by a segmentation neural network (115). In embodiments where it is not possible to access future frames, then segmentation and feature extraction may be performed using only the current frame and T prior frames.

In traditional processing, the output (109) of feature extraction (105) is typically followed directly by a segmentation network (110), which processes data at the same spatial resolution as the output of the feature network, In an embodiment, to expedite processing and reduce the complexity of the segmentation NN (115), one may insert a spatial down-sampling step (110) between the two networks, so segmentation is performed at a lower spatial resolution (say, ½, ¼, or ⅛, and the like, of the input spatial resolution). For example, in an embodiment, such sub-sampling can be performed either by pooling layers or strided convolutions at the back-end of feature extraction NN (105) or at the front-end of segmentation NN (115), or one can use any known sub-sampling techniques known in the art.

In an embodiment, to improve the final segmentation output, one may tap the early stages of the feature extraction NN (e.g., the first 3-4 layers of the network) and extract features at a high resolution (e.g., as high as the resolution of the input video) (107) which can guide a spatiotemporal filter (125) to be further discussed later on. Thus, while the outputs of feature-extraction NN are at full resolution (same as the resolution of input video (102)), the output (117) of the segmentation NN is at a lower resolution (e.g., one half or one fourth of the input resolution, or lower).

The feature extraction and segmentation networks (105, 115) can be a series of convolutional neural networks (CNNs) trained either through the whole processing pipeline or they can be pretrained CNNs. For example, in an embodiment, feature extraction was performed using the CNN model VGG19 in Ref. [1-2]. Segmentation can be performed by any known in the art method (e.g., see Ref. [3]). The core idea herein is that the intermediate output (107) of neural network 105, pulled from initial layers of the model, serve as a first good feature extractor to be used later to improve the output of a segmentation NN.

In general, in feature extraction networks, the first few layers extract more shallow low level features (e.g., edges, texture, color, and the like) and the deeper layers extract more semantic features (e.g., is this a human or a plant). The final segmentation map is usually extracted after many layers (the deeper part of the network) since that will enable it to have more information regarding what objects are present in the image.

Segmentation networks may be trained as a per pixel classification algorithm. During training, cross entropy loss with ground-truth labels is calculated at each pixel and back-propagated into the network. For example, the ground truth labels for a binary algorithm (e.g., one with two classes: object and background) would be a per pixel map with 0s for the background and is for the foreground.

Given the low-resolution output of the segmentation NN (117), a source-map upsampler (120) brings its resolution back to the same resolution as the input image. As depicted in FIG. 1, a spatiotemporal filter (125), to be discussed in more detail later, processes the following inputs:
High resolution feature map data (107), from feature-extraction NN (105)
Source segmentation-map data (122), the up-sampled source-map-output of the segmentation NN (115)
   The output (127) of this spatiotemporal filter represents the final output segmentation map at the original high resolution.

Note that up-sampling filter 120 may use any known in the art filter, like bilinear or bicubic interpolation, spline interpolation, and the like, or in an embodiment, it can be part of the segmentation NN 115. For example, up-sampling can occur at the back-end of the segmentation NN (115).

### Spatiotemporal Filtering

A conventional bilateral filter can be expressed as

$${BF [ I ]}_{p} = \frac{1}{{W}_{P}} {\sum }_{q ∈ S} {G}_{{σ}_{s}} ( ‖ p - q ‖ ) {G}_{{σ}_{r}} ( ‖ {I}_{p} - {I}_{q} ‖ ) {I}_{q} \qquad ( 1 )$$

where,
BF[I]ₚ denotes the filtered image,
p is the coordinate of the current pixel being filtered,
q is a pixel located in the window S, typically an M×M window surrounding pixel p, e.g., M=3 or higher,
Iₚ and I_{q} are pixel values at pixel locations p and q of the image to be filtered,
G_{σ}_{ₛ} and G_{σ}_{ᵣ} are Gaussian functions that measure affinity in space and intensity respectively and are calculated as follows,

$${G}_{σ} ( x ) = \frac{1}{2 π {σ}^{2}} {e}^{- ( \frac{{x}^{2}}{2 {σ}^{2}} )} . \qquad ( 2 )$$

Variables σₛ and σᵣ denote the standard deviations for the Gaussian affinity functions constructed and can be tuned as hyperparameters to control the shape of the Gaussian (usually around 10.0),
Wₚ is calculated as,

$${W}_{p} = {\sum }_{q ∈ S} {G}_{{σ}_{s}} ( ‖ p - q ‖ ) {G}_{{σ}_{r}} ( ‖ {I}_{p} - {I}_{q} ‖ ) . \qquad ( 3 )$$

An extension to the bilateral filter is the Joint Bilateral Filter, which utilizes a guidance/reference image to calculate the range kernel,

$${JBF [ I ]}_{p} = \frac{1}{{W}_{P}} {\sum }_{q ∈ S} {G}_{{σ}_{s}} ( ‖ p - q ‖ ) {G}_{{σ}_{r}} ( ‖ {I}_{p}^{r e f} - {I}_{q}^{r e f} ‖ ) {I}_{q} , \qquad ( 4 )$$

where, for output JBF[I]ₚ at pixel location p, now
I^{ref} is the reference image, and
I is the source image to be filtered.

For guided up-sampling, one can utilize the high resolution guide image as the reference image. For example, a colorization or style transfer operator can be applied to a low resolution version of the image and the original image can be used as a guide to upsample the low-resolution transformed image. Given a binary segmentation algorithm, for an input image, one can get a pixelwise confidence mask with values 0-1 (e.g., 0 denotes low confidence and 1 denotes very high confidence that a certain object is present). One could process the low resolution version of the image using this segmentation algorithm and upsample the output mask using the original high-resolution RGB image as a guide. While the intensity values of the guide image give a good approximation of the edges present in the guide image, the algorithm is sensitive to edges created by texture and shadow. Additionally, using only intensity values may not help in creating affinity functions that match textures or patterns (e.g., a human hand against sand).

In an embodiment, a novel spatiotemporal filter (125) is proposed that utilizes three distinct components:
1. Spatial and temporal distance
2. Texture and color similarity, drawn from network feature maps of the original image and input images over time
3. Segmentation likelihood, drawn from a low-resolution segmentation map (e.g., 107)
   In an embodiment, this joint spatiotemporal trilateral up-sampling filter is described as:

$${stJTF [ I ]}_{p} = \frac{1}{{W}_{P}} {\sum }_{q ∈ S} {I}_{q} {G}_{{σ}_{s t}} ( ‖ p - q ‖ ) {G}_{{σ}_{m}} ( \vert {I}_{p} - {I}_{q} \vert ) {\prod }_{n = 1}^{N} {G}_{{σ}_{fn}} ( \vert {F}_{p}^{{ref}_{n}} - {F}_{q}^{{ref}_{n}} \vert ) \qquad ( 5 )$$

where, for output stJTF[I]ₚ at pixel location p:
G_{σ}_{_{fn}} and G_{σ}_{ₘ} are Gaussian functions as defined in eq. (2) that measure affinity in the source images in space/time and intensity respectively,
N is the number of layers of feature maps. (e.g., N=128)
q is a pixel located in the spatio-temporal window S of size M×M×(2T+1),
p is now defined in the coordinate and time space as (x, y, t), with t∈[−T, T],
I_{q} and Iₚ denote the pixel values of the image to be filtered at pixel positions p and q,

$${F}_{p}^{{ref}_{n}}$$

is pixel value at position p at the n-th feature map, (e.g., n=1, 2, . . . N),
G_{σ}_{ₛₜ} is a multivariate Gaussian defined as,

$${G}_{{σ}_{s t}} ( x ) = \frac{1}{{( 2 π )}^{\frac{d}{2}}} {\vert \sum \vert}^{- \frac{1}{2}} {e}^{- \frac{1}{2} x {\sum }^{- 1} {x}^{T}} , \qquad ( 6 )$$

where Σ is a covariance matrix defined as,

$$\sum = [ \begin{matrix}{σ}_{s}^{2} & 0 & 0 \\ 0 & {σ}_{s}^{2} & 0 \\ 0 & 0 & {σ}_{t}^{2}\end{matrix} ] ,$$

and d denotes the length of the covariance matrix, e.g., in this case, d=3.
σₛ and σₜ are now the standard deviations in the spatial and temporal axes, which allows us to control the affinity functions along the axes individually.
Wₚ is calculated as,

$${W}_{p} = {\sum }_{q ∈ S} {G}_{{σ}_{st}} ( ‖ p - q ‖ ) {G}_{{σ}_{m}} ( \vert {I}_{p} - {I}_{q} \vert ) {\prod }_{n = 1}^{N} {G}_{{σ}_{fn}} ( \vert {F}_{p}^{{ref}_{n}} - {F}_{q}^{{nref}_{n}} \vert ) \qquad ( 7 )$$

For each pixel p, window S is now of size M×M×(2T+1), where (2T+1) denotes the number of frames used in the temporal domain including the anchor (current) frame, typically around 3 or 7. This corresponds to a temporal window that includes: T frames before the current frame, the current frame, and T frames after the current frame. As mentioned before, when future frames are not available, filtering may be performed using only T prior frames. The spatial window size M can be similar to the size used in the spatial bilateral filter. N is the number of feature layers (to be explained more later). Naturally, in some embodiments, a 3D Gaussian kernel could be split into separable 2D or even 1D Gaussian functions for increased computational efficiency. Because of the use of a temporal window with 2T+1 frames, to generate the source feature maps (122) more efficiently the processing steps of feature extraction (105), segmentation (115), downsampling (110), and up-sampling (120) can be duplicated 2T+1 times, thus allowing for parallel processing. Thus, the input to spatio-temporal filtering (125) includes 2T+1 source-maps and (2T+1)×N feature maps, and generates an output feature frame for the current input frame.

Spatiotemporal distance kernel (G_{σ}_{ₛₜ})

From equation (6), the spatiotemporal distance kernel, G_{σ}_{ₛₜ} (∥p−q∥), is a 3D kernel whose sigma values (standard deviation in the Gaussian equation) for space and time may be tuned separately. In practice, a sigma value for space (σₛ) should be a standard deviation around 5 pixels when the segmentation map is being upsampled four times (4×) (e.g., it should be larger when a higher upsampling scale is used), and a sigma value for time (at) should be a standard deviation around ¼ second (converted to frames at 24 fps; 5 frames—an odd number—maintains uniformity).

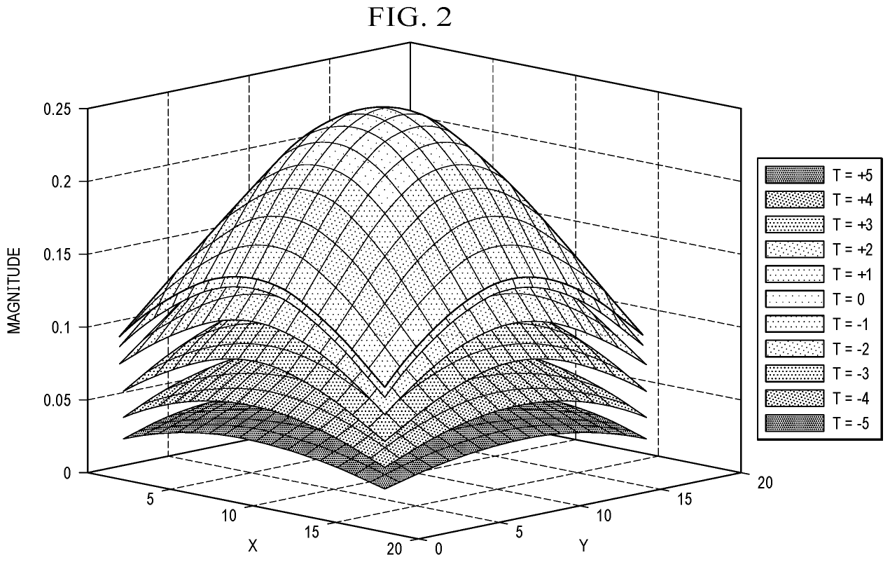

FIG. 2 depicts examples of the Gaussian kernels for times T=±5 frames. The closer the kernel is in time T=0, the higher weight it achieves. Extending this filter into the temporal domain helps correct for flicker in the output segmentation maps of video due to subtle changes on the input image which result in larger feature-map differences on the output. The amount of flicker reduction can be tuned based on the sigma in time. It is preferred that the filter is able to both look ahead and look behind (have plus or minus T≠0). In some live-video cases where this is not possible, look-behind only filters can be used, but this may yield some dragging artifacts in the feature map.

### Feature Map Based Range Kernel (G_{σ}_{_{fn}})

In equation (4), the traditional range Gaussian,

$${G}_{{σ}_{r}} ( ‖ {I}_{p}^{r e f} - {I}_{q}^{r e f} ‖ ) ,$$

acts as a sort of edge detector in an image. It compares the pixel p along with all pixels q in a window and takes the magnitude of this difference. Traditionally this is done on intensity (RGB or Y differences). More advanced methods would include using a perceptually uniform color space. However, these methods would still fail when presented with two objects of similar color.

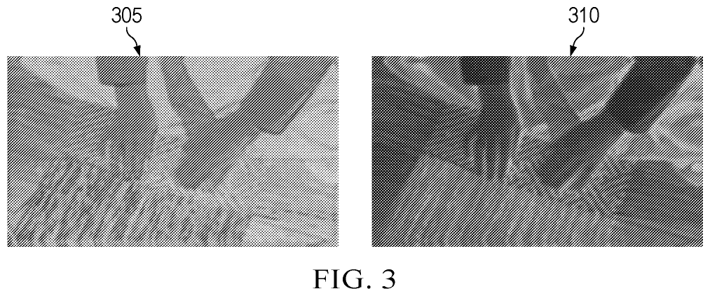

In an embodiment, it is proposed to use both color and texture information from the original (guide) image as the range-affinity Gaussian. To do this, as depicted in FIG. 1, filtering is using the high-resolution, low-level feature maps (107) from the initial layers of a CNN based neural network (105) (hence it is denoted as “sigma-f” for “feature”) to construct our Gaussian function. For example, one can extract feature maps after the fourth convolutional layer in the commonly used VGG19 (Ref. [1-2]). Similarly, examples of segmentation NNs can be found in Ref. [3]. The exact layer number would have to be experimented with for a particular model, but some heuristics, like: kernel sizes used, the number of non-linearities, and matching the receptive field with the pattern/texture size could help with selecting where to divide the neural network. FIG. 3 depicts two examples (305, 310) of feature maps extracted from an input video frame, the two examples picked at random from the 128 output channels at layer 4 of VGG19.

For improved performance and efficiency, the feature maps are extracted from the segmentation network itself. For example, one may utilize dilated convolutions in the initial layers to maintain the size of the features and implement simultaneous training of both these feature maps and the segmentation maps. Sigma values for this filter may be optimized layer by layer for improved performance, in which case one would have N sigma values for σ_{fn}, n=1, 2, . . . N, e.g., N=128.

Another advantage of using feature maps is that it reduces the amount of dragging artifacts from the temporal axis created if using the incomplete information from the color affinity functions.

### Segmentation Confidence Kernel (G_{σ}_{ₘ})

The final element in our trilateral filter is the feature-map Gaussian filter. The segmentation map already provides confidence in the location of the segmented object. Using this information, one can weigh (with variable weights) the likelihood of a pixel belonging to the map, being excluded from the map, or being in an uncertain zone. The proposed Gaussian function, G_{σ}_{ₘ} (|Iₚ−I_{q}|), uses the up-sampled segmentation map. Sigma for this filter (σₘ) tends to be best around 0.2 for a binary mask. It is possible to use the smaller resolution segmentation map and interpolate the output for improved efficiency.

### Bringing the Kernels Together

In the end, each of the kernels are multiplied together and their product is applied to the upsampled source map I (122). In practice, using bilateral upsampling for source-map upsampling works well. Alternatively, if one increases the spatial kernel, one may also consider using nearest-neighbor upsampling.

Once the source-map (122) has been multiplied by the kernel, the values are summed up in a traditional convolution operation over three dimensions. The result is that edges of the upsampled segmentation map are aligned with the edge from the original image, providing temporally stable, edge aware, segmentation maps.

### Improved Model Efficiency

In other embodiments, the proposed method can be implemented in a more parallel fashion which can improve speed and efficiency. For example, if the system benefits from lots of memory storage, one method to improve speed is to save the feature (G_{σ}_{_{fn}}) and source kernels (G_{σ}_{ₛₜ}) computed from previously processed images. The spatiotemporal kernel is constant, so this can be saved for all frames to use. Saving previously used kernels allows, on the current frame, to simply compute the kernels for the current frame alone and directly multiply the older kernels together. The speedup would be directly proportional to the time window one is using.

In a system that benefits from parallelization, all frames within a time window can be computed at once. Since only the final multiplication depends on other frames, the majority of the complex processing can be done in parallel.

If a system that is best at sequential processing, one may be able to utilize smaller parallelization efforts. Since the feature maps are coming from the early layers of the segmentation machine learning algorithm, the feature maps are generated before the source-segmentation map is complete. During this time, one can begin to create the feature kernels (G_{σ}_{ₛₜ}) so that everything is precomputed after the upsampling right when the source-map is complete.

Other ways to improve model efficiency involve the kernel sizes themselves. The proposed standard deviations (sigmas) proposed earlier do not directly relate to the actual size of the kernel itself. Reducing the size of the kernels will affect the output as the sigma and the size become closer together, however reducing the size is an efficient method at speeding up performance. Another approach would be to convert the kernel convolutions to multiplication in the Fourier domain.

### Other Applications

While example embodiments described here cover mostly improvements in feature extraction and segmentation, a person skilled in the art would appreciate that the use of the proposed spatiotemporal filter, which is guided by both input data and high-resolution guide images, is applicable to multiple other applications where sub-sampling is used to reduce computational complexity. For example, without limitation, suggested applications in video processing include tone mapping or end-to-end video coding applications.

### REFERENCES

Each of these references is included by reference in its entirety.
1. J. Johnson, A. Alahi, and L. Fei-Fei, “Perceptual losses for real-time style transfer and super-resolution,” In Computer Vision-ECCV 2016: 14th European Conference, Amsterdam, The Netherlands, Oct. 11-14, 2016, Proceedings, Part II 14 (pp. 694-711). Springer International Publishing, also in arXiv: 1603.08155v1. 27 Mar. 2016.
2. K. Simonyan, and A. Zisserman. “Very deep convolutional networks for large-scale image recognition.” arXiv preprint arXiv:1409.1556 (2014).
3. F. Sultana, A. Sufian, and P. Dutta, “Evolution of image segmentation using deep convolutional neural network: a survey,” arXiv preprint arXiv:2001.04074v3, May 29, 2020.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions related to image transformations, such as those described herein. The computer and/or IC may compute any of a variety of parameters or values that relate image-segmentation processes described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder or the like may implement methods related to image-segmentation processes as described above by executing software instructions in a program memory accessible to the processors. The invention may also be provided in the form of a program product. The program product may comprise any tangible and non-transitory medium which carries a set of computer-readable signals comprising instructions which, when executed by a data processor, cause the data processor to execute a method of the invention. Program products according to the invention may be in any of a wide variety of tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### Equivalents, Extensions, Alternatives and Miscellaneous

Example embodiments that relate image-segmentation processes are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Various aspects of the present disclosure may be appreciated from the following Enumerated Example Embodiments (EEEs):
EEE 1. A method for generating segmentation maps of pictures in a video sequence, the method comprising:
   receiving a sequence of video pictures in a first spatial resolution;
   for a current picture (102) in the sequence of video pictures:
      applying (105) a feature extraction neural network (NN) to the current picture to generate at the first spatial resolution: a first set of one or more feature-maps (107) extracted from early layers of the feature extraction NN, and an output set of one or more feature-maps (109) from the feature extraction NN;
      generating (110) in a second spatial resolution a spatially down-sampled version of the output set of feature maps, wherein the second spatial resolution is lower than the first spatial resolution;
      applying (115) a segmentation neural network to the down-sampled version of the output set of feature maps to generate a segmentation map (117) at the second spatial resolution;
      generating (120) a source segmentation map (122) at the first spatial resolution by applying a spatial up-sampling to the segmentation map;
      generating filter-parameters for a spatiotemporal filter based on the first set of feature-maps (107); and
      applying the spatiotemporal filter to the source segmentation map to generate an output segmentation map (127).
EEE 2. The method of EEE 1, wherein the second spatial resolution is one-half, one-fourth, or one-eighth of the first spatial resolution.
EEE 3. The method of EEE 1 or EEE 2, wherein the filter parameters for the spatiotemporal filter comprise a spatiotemporal distance kernel (G_{σ}_{ₛₜ}), a feature map range kernel (G_{σ}_{_{fn}}), and a segmentation confidence kernel (G_{σ}_{ₘ}).
EEE 4. The method of EEE 3, wherein performing spatiotemporal filtering comprises computing:

$${stJTF [ I ]}_{p} = \frac{1}{{W}_{P}} {\sum }_{q ∈ S} {I}_{q} {G}_{{σ}_{st}} ( ‖ p - q ‖ ) {G}_{{σ}_{m}} ( \vert {I}_{p} - {I}_{q} \vert ) {\prod }_{n = 1}^{N} {G}_{{σ}_{fn}} ( \vert {F}_{p}^{{ref}_{n}} - {F}_{q}^{{ref}_{n}} \vert ) ,$$

wherein: Iₚ and I_{q} denote pixel values of the source segmentation map at pixel locations p and q,
   S is an M×M spatiotemporal window over 2T+1 consecutive pictures in the sequence of video pictures, including the current picture, T pictures prior to the current picture, and T pictures subsequent to the current picture,
   q and p are pixels located in the spatiotemporal window S,
   N is a number of the one or more feature maps,

$${F}_{p}^{{ref}_{n}}$$

denotes a pixel value at position p at the n-th feature map among the N feature maps, and
Wₚ is calculated as

$${W}_{p} = {\sum }_{q ∈ S} {G}_{{σ}_{s t}} ( ‖ p - q ‖ ) {G}_{{σ}_{m}} ( \vert {I}_{p} - {I}_{q} \vert ) {\prod }_{n = 1}^{N} {G}_{{σ}_{fn}} ( \vert {F}_{p}^{{ref}_{n}} - {F}_{q}^{{ref}_{n}} \vert ) .$$

EEE 5. The method of EEE 3 or EEE 4, wherein
   G_{σ}_{ₛₜ} comprises a multivariate Gaussian defined as,

$${G}_{{σ}_{st}} ( x ) = \frac{1}{{( 2 π )}^{\frac{d}{2}}} {\vert \sum \vert}^{- \frac{1}{2}} {e}^{- \frac{1}{2} x {\sum }^{- 1} {x}^{T}} ,$$

where Σ is a covariance matrix with length d, defined as,

$$\sum = [ \begin{matrix}{σ}_{s}^{2} & 0 & 0 \\ 0 & {σ}_{s}^{2} & 0 \\ 0 & 0 & {σ}_{t}^{2}\end{matrix} ] ,$$

and
σₛ and σₜ are standard deviations in the spatial and temporal axes.
EEE 6. The method of any of EEEs 3-5, wherein G_{σ}_{_{fn}} and G_{σ}_{ₘ} are Gaussian functions

$${G}_{σ} ( x ) = \frac{1}{2 π {σ}^{2}} {e}^{- ( \frac{{x}^{2}}{2 {σ}^{2}} )}$$

with standard deviations, σ, σ_{fn} and σₘ.
EEE 7. The method of EEE 4, wherein T=2, M=7, and N=128.
EEE 8. An apparatus comprising a processor and configured to perform any one of the methods recited in EEEs 1-7.
EEE 9. A non-transitory computer-readable storage medium having stored thereon computer-executable instruction for executing a method with one or more processors in accordance with any one of the EEEs 1-7.

1. A method for generating segmentation maps of pictures in a video sequence, the method comprising:
receiving a sequence of video pictures in a first spatial resolution;
for a current picture (102) in the sequence of video pictures:
applying (105) a feature extraction neural network (NN) to the current picture to generate at the first spatial resolution: a first set of one or more feature-maps (107) extracted from initial layers of the feature extraction NN, and an output set of one or more feature-maps (109) from the feature extraction NN;
generating (110) in a second spatial resolution a spatially down-sampled version of the output set of feature maps, wherein the second spatial resolution is lower than the first spatial resolution;
applying (115) a segmentation neural network to the down-sampled version of the output set of feature maps to generate a segmentation map (117) at the second spatial resolution;
generating (120) a source segmentation map (122) at the first spatial resolution by applying a spatial up-sampling to the segmentation map;
generating filter-parameters for a spatiotemporal filter based on the first set of feature-maps (107); and
applying the spatiotemporal filter to the source segmentation map to generate an output segmentation map (127).

2. The method of claim 1, wherein the second spatial resolution is one-half, one-fourth, or one-eighth of the first spatial resolution.

3. The method of claim 1, wherein the filter parameters for the spatiotemporal filter comprise a spatiotemporal distance kernel (G_{σ}_{ₛₜ}), a feature map range kernel (G_{σ}_{_{fn}}), and a segmentation confidence kernel (G_{σ}_{ₘ}).

4. The method of claim 3, wherein performing spatiotemporal filtering comprises computing:
$${stJTF [ I ]}_{p} = \frac{1}{{W}_{P}} {\sum }_{q ∈ S} {I}_{q} {G}_{{σ}_{s t}} ( ‖ p - q ‖ ) {G}_{{σ}_{m}} ( \vert {I}_{p} - {I}_{q} \vert ) {\prod }_{n = 1}^{N} {G}_{{σ}_{fn}} ( \vert {F}_{p}^{{ref}_{n}} - {F}_{q}^{{ref}_{n}} \vert ) ,$$
wherein: Iₚ and I_{q} denote pixel values of the source segmentation map at pixel locations p and q,
S is an M×M spatiotemporal window over 2T+1 consecutive pictures in the sequence of video pictures, including the current picture, T pictures prior to the current picture, and T pictures subsequent to the current picture,
q and p are pixels located in the spatiotemporal window S,
N is a number of the one or more feature maps,
$${F}_{p}^{{ref}_{n}}$$
denotes a pixel value at position p at the n-th feature map among the N feature maps, and
Wₚ is calculated as
$${W}_{p} = {\sum }_{q ∈ S} {G}_{{σ}_{st}} ( ‖ p - q ‖ ) {G}_{{σ}_{m}} ( \vert {I}_{p} - {I}_{q} \vert ) {\prod }_{n = 1}^{N} {G}_{{σ}_{fn}} ( \vert {F}_{p}^{{ref}_{n}} - {F}_{q}^{{ref}_{n}} \vert ) .$$

5. The method of claim 3, wherein
G_{σ}_{ₛₜ} comprises a multivariate Gaussian defined as,
$${G}_{{σ}_{st}} ( x ) = \frac{1}{{( 2 π )}^{\frac{d}{2}}} {\vert \sum \vert}^{- \frac{1}{2}} {e}^{- \frac{1}{2} x {\sum }^{- 1} {x}^{T}} ,$$
where Σ is a covariance matrix with length d, defined as,
$$\sum = [ \begin{matrix}{σ}_{s}^{2} & 0 & 0 \\ 0 & {σ}_{s}^{2} & 0 \\ 0 & 0 & {σ}_{t}^{2}\end{matrix} ] ,$$
and
σₛ and σₜ are standard deviations in the spatial and temporal axes.

6. The method of claim 3, wherein G_{σ}_{_{fn}} and G_{σ}_{ₘ} are Gaussian functions
$${G}_{σ} ( x ) = \frac{1}{2 π {σ}^{2}} {e}^{- ( \frac{{x}^{2}}{2 {σ}^{2}} )}$$
with standard deviations, σ, σ_{fn} and σₘ.

7. The method of claim 4, wherein T=2, M=7, and N=128.

8. The method of claim 1 wherein the initial layers comprise the first 3 or 4 layers of the neural network.

9. An apparatus comprising a processor and configured to perform the method recited in claim 1.

10. A non-transitory computer-readable storage medium having stored thereon computer-executable instruction for executing a method with one or more processors in accordance with claim 1.
